(19) United States
(12) Patent Application Publication
(10) Pub. No.: US 2021/0081456 A1
(43) Pub. Date: Mar. 18, 2021

(54) USER ATTRIBUTES EVALUATION SYSTEM

(71) Applicant: ATLAS INTELLIGENCE PRIVATE LIMITED, Chennai (IN)

(72) Inventors: Sameer DILIP MEHTA, Chennai (IN); Rochana SAMEER MEHTA, Chennai (IN)

(21) Appl. No.: 16/970,522

(22) PCT Filed: Feb. 25, 2019
(86) PCT No.: PCT/IN2019/050146

§ 371 Date: Aug. 17, 2020

(30) Foreign Application Priority Data
Feb. 23, 2018 (IN) 201841006905

(51) Int. Cl. G06F 16/9035; G06F 16/9038; G06F 3/0484; G06Q 50/00; A63F 1/12

(52) U.S. Cl. CPC G06F 16/9035; G06F 16/9038; A63F 1/12; G06Q 50/01; G06F 3/04847

(57) ABSTRACT

The invention relates to the system (100) for evaluation of user attributes. More particularly, the present invention relates to system for evaluation of user attributes comprising of server (114) comprising of a processor (101), a memory (103), a database (104) containing plurality of user parameters (120), a selection component (106), a classification module (107), wherein the user is evaluated for one or more modules consisting of a generator unit/component (105) based on the user choice of preference of attributes, and evaluate the user for personality traits of the individual. Additionally the invention relates to method of evaluation of user attributes using both physical mode as deck of cards and virtual mode wherein the system (100) is accessed at a user interface on a computing device connected to the server (114) on a network (115).

### FIELD OF THE INVENTION

The invention relates to the system for evaluation of user attributes. More particularly, the present invention relates to system for evaluation of user attributes and parameters. Preferably the system evaluates user attributes based on the difference between system selected and user selected predetermined set of user attributes in the system database.

### BACKGROUND OF THE INVENTION

A person or an individual can be described by a set of attributes which predominantly include behaviour al, cognitive, mental ability, and cultural bias, attitude towards various situations that arise personal and professional fronts. A set of attributes can define the nature of the individual and his or her preferences or choices towards a particular action. The user attributes can have a positive or a negative connotation. For example values like optimistic, helpful and affectionate can be drawn as positive attributes, while being wanderlust or meticulous or aesthetic have a neutral connotation.

A person who has strong leadership skill is identified by strong intellect, competence, moral character and swift decision making capability. Understanding a human perception and predicting user affinity towards a particular attribute can define the individual.

U.S. Pat. No. 8,566,256 discloses a system and method is disclosed for profiling subjects and objects based on subjects' responses to various objects for purposes of determining and presenting the objects most likely to generate the most positive response from each visitor. Object ratings, such as aesthetic response, preference, interest, or relevancy, are explicitly submitted by subjects or derived implicitly from visitor interactions with the objects. Particularly executed on computer based service system, involves cost function.

U.S. Pat. No. 7,121,830B1 discloses a method for collecting data relating to human performance skills and/or attributes comprising the steps of creating a questionnaire relating to the human performance skills of a target individual and establishing a rating scale for responses to the questionnaire. Preferably, pairs of questionnaire elements are generated that relate to opposing but complementary performance skills to exhibit the individual's versatility in terms of dichotomies. The questionnaire results are compiled and a report is generated that displays the results. It doesn't deal with all the user attributes, but specifically to evaluate the human performance skills preferably managerial and leadership skill evaluation. It depends on the questionnaire format.

U.S. Pat. No. 7,778,863B2 discloses a behaviour prediction apparatus that includes an area attribute database which stores area attributes of each of a plurality of areas in an activity area of customers; an inter-area attribute database which stores inter-area attributes between two areas; a behaviour history database which stores behaviour history of the customers in the activity area; a movement frequency database generator which generates a movement frequency database representing a movement frequency between the two areas on the basis of the individual behaviour history database; and a movement frequency model estimator which estimates a value of a parameter in a movement frequency model having area attributes and inter-area attributes as its input and a movement frequency as its output. The apparatus disclosed herein is for customer behaviour and not user attributes in general.

U.S. Pat. No. 7,950,664B2 discloses a device and method for determining the personality type of a person or a group of persons in the tradition of the Enneagram. The device includes a number of cards and each of the cards has at least a color band, an image and a group of words, which collectively identifies an ego type. It discloses a device for determination of personality type. The system is not social media implementable, it is singular in application as it identifies only personality type.

U.S. Pat. No. 8,756,184B2 discloses a method, apparatus, system, article of manufacture, and computer readable storage medium provide the ability to predict and utilize a user's attributes. Sample user behaviour and a sample user attribute are collected. A model is trained based on the sample user behaviour and sample user attribute. Using the model, a probability of a predicted user attribute based on the sample user behaviour is predicted. System depends on videos for viewing to understand user attributes.

US20150302335A1 discloses a system and method for evaluating leadership abilities and identifying leadership talent among users and organizations in a social network, and to compare the leadership abilities of a user to the leadership abilities of other users or categories of users in a social network. System evaluates a single attribute, comprises of an invite module to evaluate other users on social media or enterprise network.

Background art lacks a system that can evaluate an individual based on the user choice or preferences when given a series of user attributes to be chosen. There is a dearth of a method capable of categorizing and evaluating multi-attributes rather than a single attribute. The user choice of the user attribute or the user affinity towards a particular attribute can help evaluate the user. This is attempted in the present invention.

Accordingly, there exists a need for a system for evaluation of various user attributes. Further, there exists a need for system which evaluates user attributes based on the difference between system selected and user selected predetermined set of user attributes in the system database.

### SUMMARY OF THE INVENTION

One or more of the problems of the conventional prior art may be overcome by various embodiments of the present invention.

It is the primary aspect of the present invention to provide an user attributes evaluation system (100), comprising of:
a server (114) comprising of a processor (101), a memory (103), a database (104) containing plurality of user parameters;
one or more modules consisting of a generator unit/component (105) which randomly fetches from the database parameters specific to the evaluation and presents the same to the users (150);
a selection component (106) using which the user chooses between the presented parameters and the allotted parameters;
a classification module (107) which classifies and maps the final user selected parameters;
an evaluation module (108) that determines the difference between system selected and the user chosen parameters, computes the overall rating/scoring and presents the evaluation;
one or more user interfaces (102, 200); and
one or more data network (115),
   wherein each parameter in the database (104) is dimensionally different from the other parameters,
   wherein the server (114) is configured to present dimensionally different parameters to the users,
   wherein each user (150) is initially presented with a predetermined set of parameters,
   wherein each parameter (120) is mapped to an attribute/score/values/competency,
   wherein if a presented parameter is chosen the allotted parameter is discarded, else the presented parameter is discarded, and
   wherein the evaluation module (108) computes the scores and displays the feedback.

It is another aspect of the present invention, wherein the subject parameters are dependent parameters.

It is another aspect of the present invention, wherein the system (100) is configured for simultaneous access by one or more users (150).

It is another aspect of the present invention, wherein the discarded parameter is returned to the database (104).

It is another aspect of the present invention, wherein the user discarded parameter is not represented to the same user (150).

It is another aspect of the present invention, wherein a user (150) can be evaluated based on the discarded parameters.

It is another aspect of the present invention, wherein the system (100) is implemented over the data network (115).

It is another aspect of the present invention, wherein the system (100) works in coherence with a social media or enterprise network.

It is another aspect of the present invention, wherein the selection module (106) is configured for social media/enterprise users to choose user affinity parameters.

It is another aspect of the present invention, wherein the user (150) can determine the permission for the social media users.

It is another aspect of the present invention, wherein the evaluation results can be posted on the user's social media profile.

It is another aspect of the present invention, wherein the system (100) is configured to allow users to send requests to evaluate other users.

It is another aspect of the present invention, wherein the system (100) is a network enabled system which can be accessed using any device.

It is another aspect of the present invention, wherein the parameters are presented to the user on a digital screen.

It is another aspect of the present invention, wherein the system (100) is implemented as a mobile application.

It is another aspect of the present invention, wherein the system (100) is implemented through physical deck of cards.

It is another aspect of the present invention, wherein the feedback is preferably displayed as a spider, radar or other visually appropriate chart.

It is another aspect of the present invention to provide a method (300) for user attribute evaluation, comprising of steps:
accession (201) of the user evaluation system (100) at the user interface (102);
system bifurcation of the user parameters into pile A for choosing of the preferred attribute and pile B for discarded parameters;
allocation (202) of the user attributes or parameter by the generator module (105) of the system (100);
user choice (203) of allocated parameters else presentation (205) of un-chosen parameters in pile A labeled as presented parameters by the system (100);
accession or choosing (206) of presented or allocated parameters as per user preference;
iterative choosing of parameters from Pile A in preference over the chosen parameters until the Pile A is exhausted;
evaluation (210) of the user choice of parameter or attributes retained with the user at the end exhaustion of parameters in Pile A; and
presentation (211) of feedback based on standard responses in the system.

### BRIEF DESCRIPTION OF THE DRAWINGS

So that the manner in which the features, advantages and objects of the invention, as well as others which will become apparent, may be understood in more detail, more particular description of the invention briefly summarized above may be had by reference to the embodiment thereof which is illustrated in the appended drawing, which form a part of this specification. It is to be noted, however, that the drawing illustrate only a preferred embodiment of the invention and is therefore not to be considered limiting of the invention's scope as it may admit to other equally effective embodiments.

FIG. 1: Illustrates the flow chart of the method of user attributes evaluation according to one embodiment of the present invention.

FIG. 2: Illustrates the user attributes evaluation system according to another embodiment of the present invention.

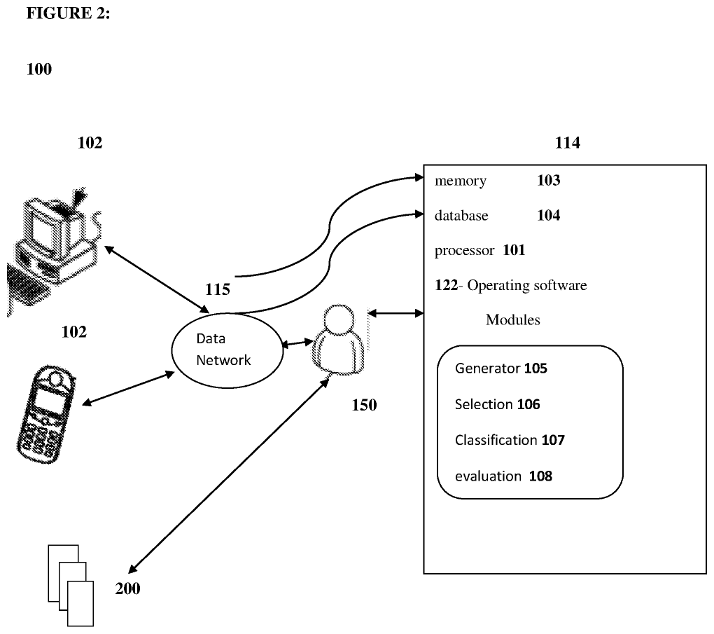

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

A system (100) for identifying the user (150) affinity for various user attributes or user parameters is provided herein. The invention is devised to evaluate a user (150) for choice of parameters, as used herein throughout the specification or the preferred choice of the user for various attributes or parameters that define personality and characteristics of an individual or personality traits of an individual.

The assessment module or evaluation module as disclosed in the preferred embodiment of the present invention finds application in coaching, counselling, education, team building, health diagnostics, psycho analysis, family business next generation development, leadership development, family bonding advisory and health or social interventions and coaching.

A preferred embodiment of the present invention illustrates a system (100) used to implement the user evaluation exemplary of the present invention. The system includes a server (114), one or more user interfaces (102) at computing devices (102). Computer data Network (15) may for example be the public internet, or local area network or any other computing network known to those of ordinary skill in art. The server (114) is controlled by the administrators of the job as disclosed herein. The server (114) is further in communication with numerous other network interconnected computing devices that may be controlled by various users at various destinations.

The memory (103) is configured to store the software (122) to enable server to execute the steps of user evaluation as disclosed herein in the embodiments of the present invention. The server (114) comprises of a processor (101), a memory (103) for storage of data (103), a database (104) containing plurality of subject or user parameters. Various modules as generator component (105) which randomly fetches from the database (104) parameters specific to the evaluation and presents the same to the users (150), a selection component (106) using which the user chooses between the presented parameters and the allotted parameters, a classification module (107) which classifies and maps the final user selected parameters, and an evaluation module (108) that determines the difference between system (100) selected and the user (150) chosen parameters, computes the overall rating/scoring and presents the evaluation. The system (100) is accessible on any of computer implementable devices selected form one or more of computer, mobile device or any computer implementable device that communicates with the system or application via a network. Some examples of user devices include computers, tablets, mobile devices, or any computer implemented device or PDA.

A particular embodiment of the present invention comprises the user attributes or parameters evaluated and that each parameter in the database (104) is dimensionally different from the other parameters. The user parameters (120) are attributes of choice or preference of the user, and encompasses values, principles to which the user may chose to adhere. Broadly the parameters are Kind-compassionate, Healthy-Hale and Hearty, Integrity-Principled, Romance-Enchantment, Responsible-Accountable, Intelligent-Bright, Diplomatic-Factful, Focus-Dedicated, Adventurous-Seeking Thrills, Action Oriented-Energetic, Ambition-Leal, Carefree-Playful, Recognition-Acknowledgement, Influential-Significant, Flexible-Adaptable, Generous-Giving, Honest-Truthful, Wise-Learned, Destiny-Fate, Peace-Harmony, Powerful-Strong, Variety-Diversity, Vibrant-Colourful, Unique-Distinctive, Thoughtful-Contemplative, Loyal-Faithful, Friendly-Amiable, Leader-Guide, Encouraging-Supportive, Straightforward-Honorable, Smooth-Sophisticated, Relaxation-At Ease, Passionate-Keenly Desirous, Loving-Affectionate, Curious-Inquisitive, Celebrate-Fesitive spirit, Funny-Amusing, Belief-Faith, Resilient-Tenacious, Equality-Parity, Orderly-Methodical, Enterprising-Resourceful, Perfectionist-Exacting, Meticulous-Thorough, Precision-Accuracy, Family Centric-Focused on Family, Brave-Courageous, Calm-Serene, Problem Solving-Solution oriented, Dutiful-Conscientious, Innovative-Out of the box, Open Minded-Broad Minded, Wanderlust-Desire to see the world, Gracious-Courteous Goodwill, Independent-Self Governed, Respect-Esteem, Aesthetis-Tasteful, Team Work-Collective Effort, Hard Work-Diligent, Optimistic-Positive.

In one embodiment, the system (100) to evaluate and score the user or users based on the choice of user affinity parameters or user attributes is provided. Individuals possess different attributes which are user defined. The attributes could broadly be behavioral, mental ability, thinking ability, leadership and so on. In a preferred embodiment the system is a computer implemented system (100) to evaluate the user affinity parameters based on the user choice of said parameter which is computed and evaluated by a series of computer implemented instructions and various modules each configured to compute based on computer executable instruction in the system.

A user (150) may have a particular affinity for any particular attribute and this affinity is stored in the database (104) of the system (100). In one embodiment the system (100) comprises of user interface (102, 200) enabling the user access to the website or the application and configured to create a user profile, storage means or memory (103) for storing the user data and the user affinity parameters (120) in the system (100). The software (122) enables the server (114) to execute the steps of the user evaluation or method. The server (114) has modules comprising of a generator (105) in the system which randomly fetches from the database (104) relevant user affinity parameters (120) when the user (150) accesses the system (100). A classification module (107) or grading module which determines and registers in the system a value or factor, which is more positive or less positive based on predetermined factor or connotation assigned to a given user affinity parameter (120). An input processor unit (101) which computes or processes the input entered by the user and also extracts the user affinity parameter from the database (104) in response to a given user input. An evaluation module (108) that determines the difference between the systems selected parameters and user selected parameters for computation of the overall score by the scoring module (108). The scoring module is configured to analyze the input of the user and assign a score through computer executable instructions implemented by the software (122). This score is plotted as a graph or a spider chart or a radar chart in comparison with the benchmark responses stored in the database of the system. Standards and benchmarks are framed with comparisons with others in similar geographies, age groups, demographics, cultural backgrounds, functional roles, enterprises, industries, departments or life model situations. Standards and benchmarks are developed using advanced data analytics, deep learning data science models and machine learning algorithms.

The system is network (115) enabled and can be accessed by a plurality of devices (102). The plurality of devices includes desktop computers or handheld mobile devices configured to access the internet and/or a social network system that may reside on the internet.

In another embodiment, the computing device may be one or more of a user computer, which may include, but is not restricted to, desktop computers or handheld mobile devices configured to access web pages. The user account module is configured to create a user account and profile. The user account module is further configured to request the user to enter personal information. The personal information entered by the user may include, but is not restricted to, name, contact information and other relevant details and so on. Upon creating the user profile, a unique identifier (ID) is created by the user account module, and the personal and professional information entered by the user is associated and securely stored in the memory along with the created unique ID. Upon the establishment of an account and profile by a user. A user who can be an individual or more than one individual's who can access the system for evaluation of the user affinity attributes or parameters by at multiple devices over the network (115). This system is implemented over the network or through the website or through social network system that may reside on the internet.

An embodiment of the present invention uses the system comprising either a physically implementable module as in a deck of cards (200) displaying the various user affinity parameters or a virtual module accessed through the internet on any one of the aforesaid devices. In the physical module the user is dealt in with between 3 and 7 deck of cards depicting the user affinity parameters. The system has a dealt in pile A and a discarded pile B. The cards display the user attributes as indicia or text or mark with a display picture, user is required to choose a card from the dealt in pile A. The user draws a card from dealt in pile may and exchanges it the given set of dealt in hand cards, discarding the exchanged card to pile B, user iteratively performs this until the pile having dealt in cards is exhausted. The user is evaluated based on the final choice of dealt in cards retained with him/her for the most valued user affinity parameters. In the physical module an evaluation and feedback cannot be plotted. But the user is evaluated based on the choice of attributes on the cards.

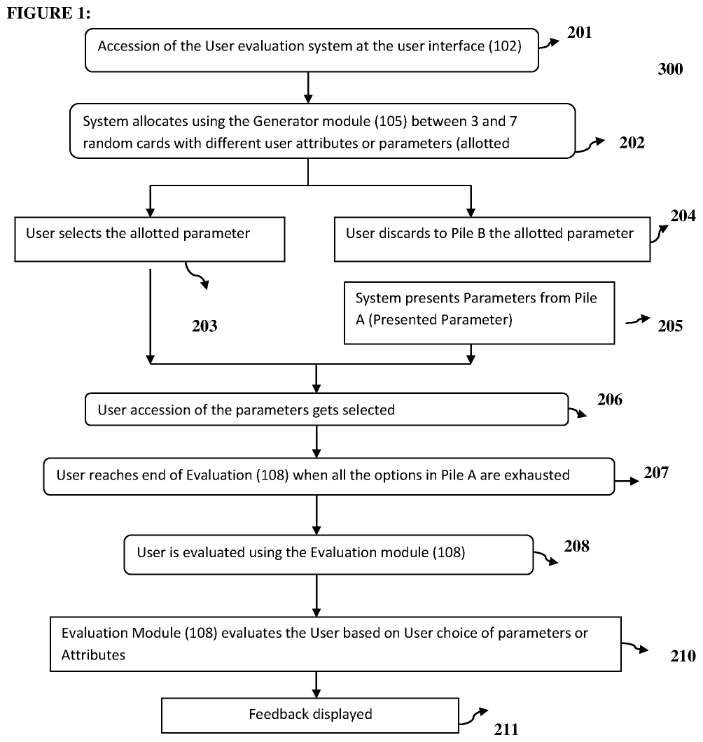

Another embodiment of the present invention is the virtual module exemplary of the present invention and illustrated in FIG. 1, which uses the system (100) to evaluate the user attributes wherein the system is provided with a collection of user attributes graded/classified based on a predetermined positive or negative factor attributed to the said user attribute. The user accesses (201) the database (104) using the user platform/interface (102). The user is allocated (202) with 5 random system selected user parameters or attributes by the generator module (105) of the system. The user is further presented (205) with another set of 3 system selected user parameters or attributes. The user can either select (203) or discard (204) from the set of 3 system presented parameters which is computed by the selection module (106). In case of choosing a system presented parameter, one of the system allocated parameter gets discarded, else the system presented parameter gets discarded, wherein the user iteratively chooses the parameters until he arrives at the most valued parameters.

The user may also be evaluated using the discarded parameters, as the discarded parameters depict the user choice of preference for given attributes and provide a method for user personality evaluation. Since the user is choosing from a limited quantified set of user attributes presented by the system according to his affinity for a given user attribute or parameter, there is less scope for anomaly in interpretation and further evaluation of the user. The user reaches (207) end of Evaluation when all the options in Pile A are exhausted. The evaluation module (108) of the system evaluates (208) the user based on the difference between the system selected and user selected final set of user attributes chosen (210). The evaluation module computes the scores and displays the feedback most preferably as a spider chart, radar chart or other visual charts (211).

An embodiment of the present invention uses the system to evaluate the user attributes wherein the system is provided with a collection of user attributes graded/classified based on a predetermined positive or negative factor attributed to the said user attribute. The user accesses the database using the user platform/interface (102). The user is allocated with one random system selected user parameters or attributes based question by the generator means of the system. These form the allotted parameters, the system may further present more parameters to the user from a dealt in pile A which are the presented parameters. The user will choose 5 parameters each according to his or her preference for different points in time defined as the past, present and future. If the user attributes are reflected in the allocated it is retained, if it is not reflected the user has the option to select the Pile A for more user parameters, which are termed as presented. If the user chooses the presented parameter, allocated parameter is discarded to Pile B. This process is iteratively done until the pile A is exhausted of the attributes and is empty. Based on the choice of user attributes chosen for the different time lines (past, present and future) the system (100) performs an evaluation. The evaluation module (108) of the system evaluates the user based on the user selected parameters. The evaluation module (108) computes the scores and displays the feedback most preferably as a spider chart or radar chart, based on the collection of user data present in the database (104).

Another embodiment of the present invention uses the system to evaluate the user attributes wherein the system is provided with a collection of user attributes defined and graded/classified based on a predetermined positive or negative factor or connotation attributed to the said user attribute. The user is allocated with one random system selected user parameters or attributes based question by the generator module (105) of the system and presented with one or more system selected parameters, and two unknown parameters, the user has to match if the system presented parameter complies with the question presented else the system presented parameter gets discarded. The evaluation module (108) of the system evaluates the user based on the database with all the user defined parameters, user choice of user attributes or parameters in response to the system presented question and the evaluation is displayed preferably as a spider chart, radar chart or other visual charts.

In another embodiment, the user may select a question based on the database of user defined parameters, and choose appropriate parameters as response to the set question, user may also define more questions based on the above user parameters chosen as response and iteratively pick up more number of user parameters as responses to the set questions. The evaluation module (108) of the system evaluates the user based on the series of user based parameters chosen as responses to the question and computes a score and displays a feedback.

In another embodiment of the present invention there can be multiple users operating on the system for evaluation simultaneously wherein the system is provided with a collection of user attributes graded/classified based on a predetermined positive or negative factor attributed to the said user attribute. The user accesses the database using the user platform/interface (102). The user is allocated with one random system selected user parameters or attributes based question by the generator (105) of the system. The user will choose 5 parameters each according to his preference for the past, present and future. Based on the choice of user attributes chosen for the different time lines (past, present and future) the system performs an evaluation. The evaluation module (108) of the system evaluates the user based on the user selected parameters. The evaluation module (108) computes the scores and displays the feedback most preferably as a spider chart, radar chart or other visual charts.

In another embodiment of the present invention there can be multiple users operating on the system (100) for evaluation simultaneously wherein the system is provided with a collection of user attributes graded/classified based on a predetermined positive or negative factor attributed to the said user attribute. The user or users accesses the system using the user platform/interface from the same or different devices. There cannot be more than 7 users accessing the system simultaneously. In case of multiple users, they can access the system by forming a group and any user can access the system based on the URL generated and join the group by accessing the system from a remote location. The multiple user module can be accessed when there are at least two users. The system presents the users with one or more user attributes or user affinity parameters, based on the preference the user can make a choice of parameter which is registered by the system, the users are evaluated by the evaluation module and the feedback is displayed.

In a preferred embodiment, in the multiple user modules the system assigns a question to the user based on the user affinity parameters in the database. It further displays a minimum of one and a maximum of eight options to the user from the user affinity or user attributes database, from which the user has to choose in ascending or descending order of preference. The system evaluation module (108) computes the score based on a predefined set of user parameters which are classified or graded by the computer and a positive or not very positive connotation or factor is attributed to a given user affinity parameter. The users are evaluated by the evaluation module (108) and the feedback is displayed. The scoring using the scoring module also may be computed for multiple users based on their choice of preferences for the user affinity attributes or parameters, each user's choice of affinity parameters may be different. Users are evaluated by the evaluation module and the feedback is displayed. The system scores using the scoring module (108) based on the predefined set of values based on the connotation attributed to each parameter in the database.

The embodiments of the present invention are configured to not only evaluate user based on the choice of parameters but both in physical and virtual mode the discarded parameters are also indicative of the user choice of preference of the user attributes, thus enabling evaluation of the user personality trait.

### Example 1: Physical Deck of Cards for User Attributes Evaluation

The user can access the system for evaluation of the parameters or attribute by a physical means, wherein the interface is a physical deck of cards. User is evaluated for the selection of user attributes.

The user first has a physical deck of cards which bear indicia or plurality of card-like devices, each bearing indicia, or physical deck of cards. A plurality of card-like devices, include indicia depicting various symbols or marks and Text or titles representing the user attributes. One face of the cards has a uniform representation and the other face or face B of the card bears the representation as text and image or indicia depicting the user attribute. There are set of 60 user attributes belonging to various classes. One or more users (minimum of 2 and maximum of 6) should distribute between 3 and 7 cards each amongst themselves. The remaining cards are piled as Pile A with top card face up in a new pile (Pile B).

Each user is allowed to withdraw a single card from Pile A or Pile B and discarding the card which is lesser in value as determined by the user, this gives an indication of the user preference for a particular attribute. The users can compare the cards in hand and also swap the cards for preference of a particular user attributes. The cards and the user preferences can be classified as Priority user values or attributes, Preferential user attributes, Perceived attributes wherein a user can evaluate another user for exchange or swapping of a given card from the deck of cards. The user attribute evaluation system is devised to identify and understand the user preferential attributes from the set of attributes, and is devised at identifying the priority of the user for a given set of values.

### Example 2: User Attribute Evaluation System-Single User Format

User chooses the system for evaluation of user attributes in any one of the network implementable devices like a computer, desktop, mobile or ipad. The user evaluation system is made available as a website that can be accessed online using any network or accessed as an application in any one of the network enabled devices. The user is required to create a profile online using the user interface at the website or the application downloaded on the mobile (for eg.). The user creates a user profile on the system by signing up. The system also provides alternate means for logging in using existing Google® or social media profiles of the user., for e.g. A Facebook® profile. The system provides a virtual deck of cards, which are in principle the same cards or card like devices which are on the virtual media displaying on side A the indicia and on side B the values or user attributes with text or distinct marks, which depict a particular user attribute. The deck of cards can be customized for multiple languages. There are two modes a single user mode and a multiple user mode, which can be chosen based on user preference. The system provides the user evaluation in multiple languages selected from: English, French, German, Italian, Portuguese, Spanish, Greek, Dutch, Polish, Russian, Arabic, Swahili, Tamil, Guajarati, Kannada, Malayalam, Hindi, Cantonese, Mandarin, Urdu, Bahia and so on. The profile of the user on the user attribute evaluation system is password protected. Different modules of the system are available which evaluate the user based on:

Priority user attributes that the user may choose from the set of attributes termed as the “Priority module”.

In the Priority module the user is provided an option of Pile A and Pile B. The user is provided with three options on accession to the system, from Pile A, the user may choose an attribute of his choice or swap a particular attribute for a lower or higher attribute according to preference. The system is configured to discard the virtual card not chosen, to Pile B. The user choice of values as compiled by the choices made is displayed as the top choices on the system

### Output

The system will provide the reorganized or re-structured order of attributes (or values) of each of the users in a graphical list.

Outcome is displayed as a radar chart or other visual charts.

The system is also configured to evaluate a user based on a given questionnaire. In the “Selfie Module” this is accessible, all the modules can be chosen by the user at the beginning of the accession of the system. The system is configured wherein the user when he chooses a particular module of Selfie leads to a question, which is answered by choosing the virtual deck of cards. The user is displayed with options to classify the cards, based on user preferences for future, past, present. The cards displaying user attributes which the user finds unimportant are moved to a virtual pile of Rejection. The user is evaluated based on the user preferences for the given set of values displayed and the outcome is provided in terms of a spider chart. The response of the user is compared to a standard reference response devised by the system.

Other auxiliary modules are “The Survey Module”, wherein the user has the choice of providing to the system as a feedback form, for series of questions which are devised to evaluate the user preference for values. The user is evaluated by the online support of the system and the result in comparison with standard set is displayed as outcome in form of a spider chart or other visual charts.

In one embodiment is provided a “Timeline module” wherein a question is displayed by the system, the user is allowed to pick or choose an answer from the pile of cards with individual attributes displayed. The user may choose preference of attributes based on time lines i.e. currently important which is slotted as present, attributes for future, attributes which were important to the user in the past and also attributes which are deemed unimportant by the user. The evaluation of the chosen attribute is performed by the system and result based on comparison with standard values is displayed as an outcome.

The user in another embodiment the user is provided with a question, and the answers to which are displayed as virtual cards, the user has an option to choose the apt answer and discard the choices which he finds inappropriate to the question posed. The score is configured based on standard responses in the databases and the results displayed as a spider chart or other visual charts.

The user in another embodiment the user is provided with a question for evaluation of the user preference of attributes, the user has the freedom to choose set of cards to form an answer. Multiple questions are displayed wherein the user can chose and remover or add the cards in the virtual system. The score is calculated and displayed as a spider chart or other visual charts.

### Example 3: User Attribute Evaluation System in Multiple User Format

In case of multiple users each user should have an individual user profile created online or in a mobile application. A single user may even share requests to join the group wishing to access the User Attribute Evaluation system (100), The system is configured to accommodate simultaneously 7 users in a single group. A single player is chosen for the role of the administrator. Simultaneous evaluation of at least 3 players is allowed. The administrator has the choice to choose the cards or reshuffle the cards and reaccess the system more than once. The administrator may choose to send invitations to more than one unregistered users to access the system. A comparative spider chart based on the user attributes chosen and are provided with a score to define the user preference of attributes.

A preferred embodiment of the present invention for multiple players has a Competitive module for user evaluation. This module comprises of a framework wherein all the users are provided with the same set of questions. All the users are evaluated based on their choice of attributes and display of the result of evaluation as a spider chart. The strengths and weaknesses of the user is evaluated based on a predetermined set of user attributes chosen by the system.

Other auxiliary modules evaluate based on user feedback or experience sharing with the system, evaluation is based on the most favored feedback or experience shared among various users in a given group.

Multiple players in another embodiment can choose to bid for the different user attributes and the highest bidder can avail the card. Results for multiple users can be displayed on the profile in any social media network.

We claim:

1. A user attributes evaluation system (100), comprising of:
a server (114) comprising of a processor (101), a memory (103), a database (104) containing plurality of user parameters;
one or more modules consisting of a generator unit/component (105) which randomly fetches from the database parameters specific to the evaluation and presents the same to the users (150);
a selection component (106) using which the user chooses between the presented parameters and the allotted parameters;
a classification module (107) which classifies and maps the final user selected parameters;
an evaluation module (108) that determines the difference between system selected and the user chosen parameters, computes the overall rating/scoring and presents the evaluation;
one or more user interfaces (102, 200); and
one or more data network (115),
wherein each parameter in the database (104) is dimensionally different from the other parameters,
wherein the server (114) is configured to present dimensionally different parameters to the users,
wherein each user (150) is initially presented with a predetermined set of parameters,
wherein each parameter (120) is mapped to an attribute/score/values/competency,
wherein if a presented parameter is chosen the allotted parameter is discarded, else the presented parameter is discarded, and
wherein the evaluation module (108) computes the scores and displays the feedback.

2. The user attributes evaluation system (100) as claimed in claim 1, wherein the subject parameters are dependent parameters.

3. The user attributes evaluation system (100) as claimed in claim 1, wherein the system (100) is configured for simultaneous access by one or more users (150).

4. The user attributes evaluation system (100) as claimed in claim 1, wherein the discarded parameter is returned to the database (104).

5. The user attributes evaluation system (100) as claimed in claim 1, wherein the user discarded parameter is not represented to the same user (150).

6. The user attributes evaluation system (100) as claimed in claim 1, wherein a user (150) can be evaluated based on the discarded parameters.

7. The user attributes evaluation system (100) as claimed in claim 1, wherein the system (100) is implemented over the data network (115).

8. The user attributes evaluation system (100) as claimed in claim 1, wherein the system (100) works in coherence with a social media or enterprise network.

9. The user attributes evaluation system (100) as claimed in claim 1, wherein the selection module (106) is configured for social media/enterprise users to choose user affinity parameters.

10. The user attributes evaluation system (100) as claimed in claim 1, wherein the user (150) can determine the permission for the social media users.

11. The user attributes evaluation system (100) as claimed in claim 1, wherein the evaluation results can be posted on the user's social media profile.

12. The user attributes evaluation system (100) as claimed in claim 1, wherein the system (100) is configured to allow users to send requests to evaluate other users.

13. The user attributes evaluation system (100) as claimed in claim 1, wherein the system (100) is a network enabled system which can be accessed using any device.

14. The user attributes evaluation system (100) as claimed in claim 1, wherein the parameters are presented to the user on a digital screen.

15. The user attributes evaluation system (100) as claimed in claim 1, wherein the system (100) is implemented as a mobile application.

16. The user attributes evaluation system as claimed in claim 1, wherein the system (100) is implemented through physical deck of cards.

17. The user attributes evaluation system (100) as claimed in claim 1, wherein the feedback is preferably displayed as a spider/radar chart.

18. A method (300) for user attributes evaluation, comprising of steps:
accession (201) of the user evaluation system (100) at the user interface (102);
system bifurcation of the user parameters into pile A for choosing of the preferred attribute and pile B for discarded parameters;
allocation (202) of the user attributes or parameter by the generator module (105) of the system (100);
user choice (203) of allocated parameters else presentation (205) of un-chosen parameters in pile A labeled as presented parameters by the system (100);
accession or choosing (206) of presented or allocated parameters as per user preference;
iterative choosing of parameters from Pile A in preference over the chosen parameters until the Pile A is exhausted;
evaluation (210) of the user choice of parameter or attributes retained with the user at the end exhaustion of parameters in Pile A; and
presentation (211) of feedback based on standard responses in the system.
